(19) United States
(12) Patent Application Publication
(10) Pub. No.: US 2026/0313416 A1
(43) Pub. Date: Oct. 8, 2026

(54) EFFECTIVE EARLY MEASUREMENT FOR REPORTING DURING CONNECTION SETUP

(71) Applicant: APPLE INC., Cupertino, CA (US)

(72) Inventors: Qiming Li, Beijing (CN); Manasa Raghavan, Sunnyvale, CA (US); Naveen Kumar R Palle Venkata, San Diego, CA (US); Dawei Zhang, Saratoga, CA (US); Yang Tang, San Jose, CA (US); Rolando E Bettancourt Ortega, Munich (DE); Yuexia Song, Beijing (CN); Jie Cui, San Jose, CA (US); Xiang Chen, Campbell, CA (US); Hong He, San Jose, CA (US)

(21) Appl. No.: 18/998,308

(22) PCT Filed: Aug. 9, 2022
(86) PCT No.: PCT/CN2022/111075

§ 371 Date: Jan. 24, 2025

(51) Int. Cl. H04W 24/10; H04B 7/06; H04W 74/0833

(52) U.S. Cl. CPC H04W 24/10; H04B 7/0626; H04W 74/0833

(57) ABSTRACT

The present disclosure is related to techniques for performing measurement procedures (e.g., during a connection setup procedure) in a wireless communications system. In some embodiments, a user equipment device (UE) is configured to, based on a first configuration, perform a measurement procedure on at least one carrier during a connection setup procedure on a first cell, wherein the at least one carrier is associated with one or more cells including the first cell, and the first cell is provided by a network device. The UE is further configured to perform the measurement procedure to obtain measurement results for the at least one carrier, and to transmit a measurement report for the at least one carrier, containing the measurement results, to the network device.

### TECHNICAL FIELD

This application relates generally to wireless communication systems, including wireless communication systems where early measurements can be effectively performed for reporting to a network device, for example, during a connection setup procedure.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

In accordance with a first aspect, a user equipment device (UE) including one or more antennas, a transceiver, and a processor as well as a method performed by a UE are disclosed. In some embodiments, the processor is configured to cause the UE to perform the method, comprising: based on a first configuration, performing a measurement procedure on at least one carrier during a connection setup procedure on a first cell, wherein the at least one carrier is associated with one or more cells including the first cell, and the first cell is provided by a network device; performing the measurement procedure to obtain measurement results for the at least one carrier; and transmitting a measurement report for the at least one carrier, containing the measurement results, to the network device.

In accordance with a second aspect, a network device including one or more antennas, a transceiver, and a processor as well as a method performed by a network device are disclosed. In some embodiments, the processor is configured to cause the network device to perform the method, comprising: including a first indication in a first configuration to configure a user equipment device (UE) to perform a measurement procedure on at least one carrier during a connection setup procedure on a first cell, wherein the at least one carrier is associated with one or more cells including the first cell, and the first cell is provided by the network device; transmitting a message including the first configuration to the UE; and receiving a measurement report for the at least one carrier, containing the measurement results, from the UE.

In accordance with a third aspect, a network device including one or more antennas, a transceiver, and a processor as well as a method performed by a network device are disclosed. In some embodiments, the processor is configured to cause the network device to perform the method, comprising: configuring a timer for a user equipment device (UE) to perform an early measurement on a carrier; receiving a corresponding early measurement report; determining a time period between a first time when the early measurement report is received and a second time when the timer expired; determining a degradation of accuracy for the early measurement report based on the time period; and adjusting a measurement result contained in the early measurement report based on the degradation of the accuracy.

In accordance with a fourth aspect, an apparatus for operating a user equipment device (UE) is disclosed. In some embodiments, the apparatus includes a processor configured to cause the UE to perform methods disclosed herein.

In accordance with a fifth aspect, an apparatus for operating a network device is disclosed. In some embodiments, the apparatus includes a processor configured to cause the network device to perform methods disclosed herein.

In accordance with a sixth aspect, a non-transitory computer-readable memory medium storing program instructions is disclosed. In some embodiments, when executed by a computer system, the instructions cause implementation of method disclosed herein.

In accordance with a seventh aspect, a computer program product comprising program instructions is disclosed. In some embodiments, when executed by a computer system, the instructions cause implementation of method disclosed herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A illustrates an example flowchart for a measurement procedure performed during a connection setup procedure, according to embodiments disclosed herein.

FIG. 3B illustrates an example timeline for the paging-based measurement procedure in FIG. 3A, according to embodiments disclosed herein.

FIG. 4A illustrates an example flowchart for a measurement procedure performed during a connection setup procedure, according to embodiments disclosed herein.

FIG. 4B illustrates an example timeline for the random access-based measurement procedure in FIG. 4A, according to embodiments disclosed herein.

FIG. 5 illustrates an example process for determining a type of measurement to perform based on a threshold, according to embodiments disclosed herein.

FIG. 6A illustrates an example flowchart for a measurement procedure performed during an idle mode, according to embodiments disclosed herein.

FIG. 6B illustrates an example timeline for the measurement procedure in FIG. 6A, according to embodiments disclosed herein.

FIGS. 7-9 illustrates example methods for communication according to embodiments disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
CA: Carrier Aggregation
CSI-RS: Channel State Information-Reference Signal
DC: Dual Connectivity
EMR: Early Measurement Report
FR: Frequency Range
L1: Layer 1
L3: Layer 3
NR: New Radio
NW: Network
PRACH: Physical Random Access Channel
RACH: Random Access Channel
RAN: Radio Access Network
RAR: Random Access Response
RRC: Radio Resource Control
RRM: Radio Resource Management
RS: Reference Signal
RSRP: Reference Signal Receiving Power
RSRQ: Reference Signal Receiving Quality
RX: Receive
SINR: Signal to Interference plus Noise Ratio
SIB: System Information Block
SSB: Synchronization Signal Block
TCI: Transmission Configuration Indication
UE: User Equipment

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

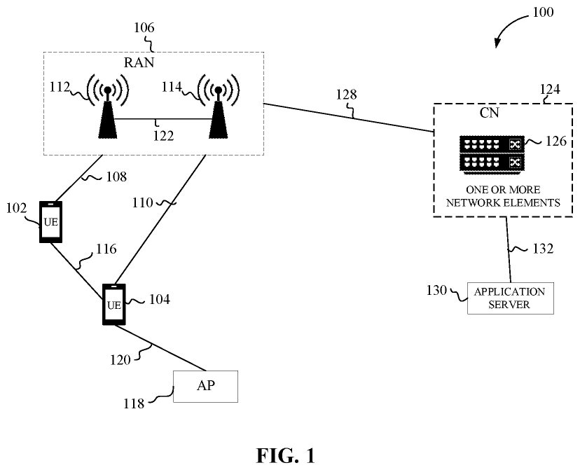

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

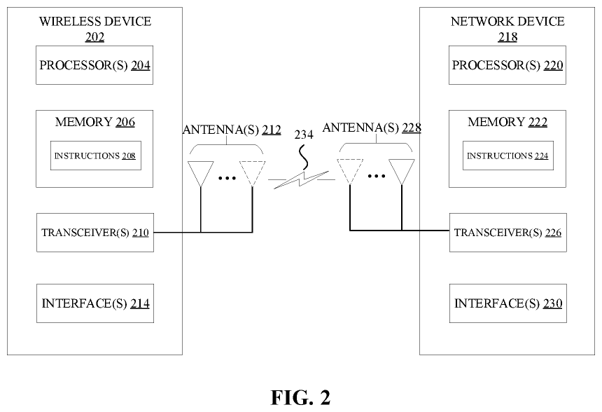

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### Measurement Procedure During Connection Setup

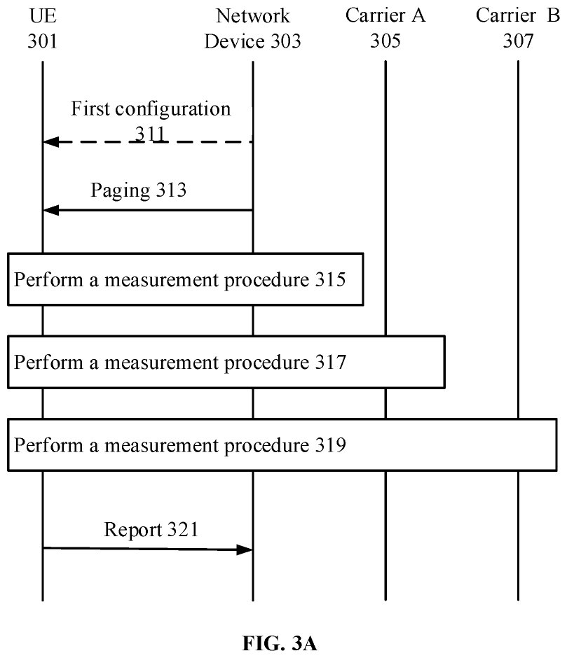

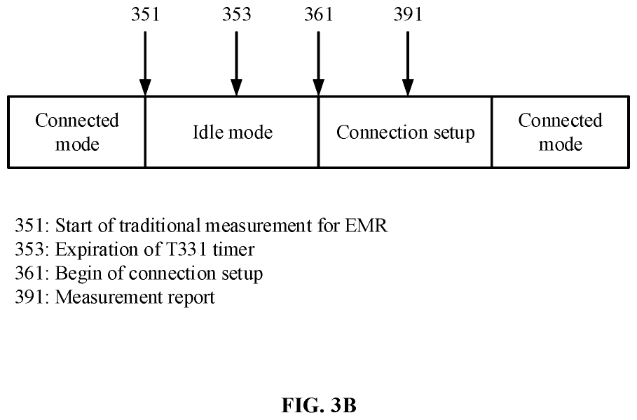

FIG. 3A illustrates an example flowchart for a measurement procedure performed during a connection setup procedure (e.g., a connection establishment procedure), according to embodiments disclosed herein. In the example of FIG. 3A, the measurement procedure can be performed in connection with a paging procedure by a UE 301. Thus, the measurement procedure can be referred to as a paging-based measurement procedure. In FIG. 3A, the UE 301 may correspond to any of the UEs and the wireless device of FIG. 1 and FIG. 2. The network device 303 may correspond to any of the base stations or the network device of FIG. 1 and FIG. 2. The network device 303 may serve the UE 301 on one or more carriers. In the present disclosure, the carrier may refer to a specific radio carrier frequency or radio channel(s) that may be used by the UEs and network devices for communication (e.g., for carrying data and data exchange).

As shown in FIG. 3A, at 311, the network device 303 provides a first configuration (e.g., in a message) to the UE 301. For example, the first configuration may be included in an appropriate SIB (e.g., SIB1), or the first configuration may be transmitted in a RRC release message to the UE 301. In some embodiments, the operation 311 may be optional in the sense that the first configuration may be predefined at both the UE 301 and the network device 303 (e.g., predefined in corresponding technical specifications).

At 313, the UE 301 is paged by the network (in particular, by the network device 303), for example, when there is upcoming traffic for the UE 301 at the network side.

At 315, based on the first configuration, the UE 301 starts the paging-based measurement procedure on one or more carriers of the network device 303, in order to obtain measurement results for the one or more carriers. In an embodiment, the UE 301 starts the measurement procedure during the paging procedure. In another embodiment, the UE 301 starts the measurement procedure after a successful paging reception.

In some embodiments, based on the first configuration, the UE 301 may further perform the measurement procedure on one or more carriers provided by more than one network devices (i.e., parallel measurement procedures). As shown in FIG. 3A, at 317 and 319, based on the first configuration, the UE 301 further starts the measurement procedure on the carrier A 305 and the carrier B 307 provided by some other network device(s), in order to obtain measurement results for those carriers. These measurement results would be useful to the network device 305 to make decisions in operations involving multiple cells or carriers, like the handover, CA and/or DC operations.

At 321, the UE 301 transmits a measurement report for the measured carrier(s), containing the measurement results, to the network device 303. The network device 303 may utilize the measurement report in configuring the UE 301 for communication or data transfer. In some embodiments, the measurement report is used by the network device 303 for configuring the UE 301 with CA and/or DC, or for triggering a handover to another cell.

FIG. 3B illustrates an example timeline for the paging-based measurement procedure in FIG. 3A, according to embodiments disclosed herein. As shown in FIG. 3B, with the initiation of the paging at 361, a period corresponding to the connection setup is entered. At this time, the measurement procedure in FIG. 3A can be started in connection with the paging procedure, and measurement results can be obtained for reporting (e.g., at 391) to the network device 303 during the connection setup period. Thus, the network device 303 can configure the UE 301 with CA and/or DC or make a handover decision without waiting for measurement results performed after entering a connected mode or based on a connected measurement configuration and measurement report triggering. In this sense, the paging-based measurement procedure is an early measurement.

In some implementations, the network device 303 may configure the UE 301 to perform a traditional measurement procedure for EMR. As shown in FIG. 3B, at 351, the network device 303 may configure the EMR with a RRC release message to the UE 301. Based on the configuration, the measurement procedure is started at 351 and finishes at 353 when a related T331 timer expires. The UE 301 may maintain the measurement results until requested by the network device 305 during the connection setup period. It will be appreciated that, although this measurement procedure is performed early to ensure the early report of the measurement results, the accuracy of the report may be low due to there is a long gap between the end of the measurement procedure and the report. For example, the report based on measurements before 353 may not accurately reflect the wireless condition at 391. Compared to the traditional EMR, the measurement procedure in FIG. 3A is a “delayed” early measurement in the sense it is started later than the traditional early measurement. Thus, the paging-based measurement procedure can reflect the current wireless condition with more accuracy.

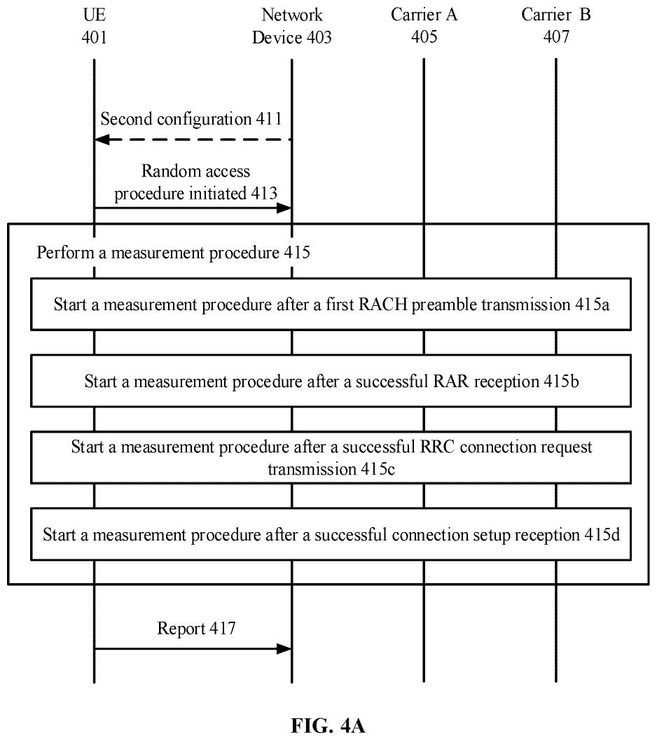

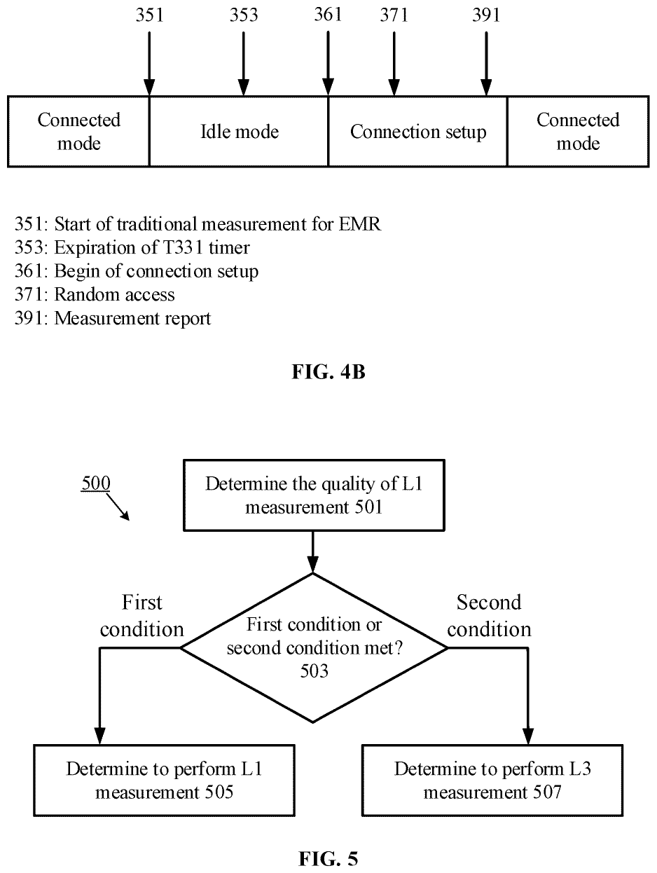

FIG. 4A illustrates an example flowchart for a measurement procedure performed during a connection setup procedure (e.g., a connection establishment procedure), according to embodiments disclosed herein. In the example of FIG. 4A, the measurement procedure can be performed during connection setup with a random access procedure by a UE 401. Thus, the measurement procedure can be referred to as a random access-based measurement procedure. In FIG. 4A, the UE 401 may correspond to any of the UEs and the wireless device of FIG. 1 and FIG. 2. The network device 403 may correspond to any of the base stations or the network device of FIG. 1 and FIG. 2. The network device 403 may serve the UE 401 on one or more carriers.

As shown in FIG. 4A, at 411, the network device 403 provides a second configuration (e.g., in a message) to the UE 401. For example, the first configuration may be included in an appropriate SIB (e.g., SIB1), or the first configuration can be transmitted in the message to the UE 401 during an RRC release procedure. In some embodiments, the operation 411 may be optional in the sense that the second configuration may be predefined at both the UE 401 and the network device 403 (e.g., predefined in corresponding technical specifications).

At 413, the UE 401 initiates a random access procedure. For example, the random access procedure may be initiated by the UE 401 from a RRC idle state or inactive state, during a RRC re-establishment procedure, or during a handover procedure. In addition, the UE 401 may initiate the random access procedure when the uplink data is arriving.

At 415, based on the second configuration, the UE 401 starts a random access-based measurement procedure on one or more carriers of the network device 403, in order to obtain measurement results for these carriers. In an embodiment, as an option 4a) at 415a, the UE 401 starts the measurement procedure after a first RACH preamble transmission (or after transmission of Msg. 1). In an embodiment, as an option 4b) at 415 b, the UE 401 starts the measurement procedure after a successful RAR reception (or after the reception of Msg. 2). In an embodiment, as an option 4c) at 415c, the UE 401 starts the measurement procedure after a successful RRC connection request transmission (or after transmission of Msg. 3). In an embodiment, as an option 4d) at 415d, the UE 401 starts the measurement procedure after a successful connection setup reception (or after reception of Msg. 4).

In some embodiments, based on the second configuration, the UE 401 may further perform the measurement procedure on one or more carriers provided by more than one network devices (i.e., parallel measurement procedures). For example, at 415, the measurement procedure may be further performed on the carrier A 405 and the carrier B 407 provided by some other network devices, in order to obtain measurement results for those carriers.

At 417, the UE 401 transmits a measurement report for the measured carrier(s), containing the measurement results, to the network device 403. The network device 403 may utilize the measurement report in configuring the UE 401 for communication or data transfer. In some embodiments, the measurement report is used by the network device 403 for configuring the UE 401 with CA and/or DC, or for triggering a handover to another cell.

FIG. 4B illustrates an example timeline for the random access-based measurement procedure in FIG. 4A, according to embodiments disclosed herein. As shown in FIG. 4B, at 361, a period corresponding to the connection setup is entered. Later, the measurement procedure in FIG. 4A can be started in connection with the random access procedure, and measurement results can be obtained for reporting (e.g., at 391) to the network device 403 during the connection setup period. Thus, the network device 403 can configure the UE 401 with CA and/or DC or make a handover decision without waiting for measurement results performed after entering a connected mode or based on a connected measurement configuration and measurement report triggering. In this sense, the random access-based measurement procedure is an early measurement.

In some implementations, the network device 403 may configure the UE 401 to perform a traditional measurement procedure for EMR. As shown in FIG. 4B, at 351, the network device 403 may configure the EMR with a RRC release message to the UE 401. Based on the configuration, the measurement procedure is started at 351 and finishes at 353 when a related T331 timer expires. The UE 401 may maintain the measurement results until requested by the network device 405 during the connection setup period. It will be appreciated that, although this measurement procedure is performed early to ensure the early report of the measurement results, the accuracy of the report may be low due to there is a long gap between the end of the measurement procedure and the report. For example, the report based on measurements before 353 may not accurately reflect the wireless condition at 391. Compared to the traditional EMR, the measurement procedure in FIG. 4A is a “delayed” early measurement in the sense it is started later than the traditional early measurement. Thus, the random access-based measurement procedure can reflect the current wireless condition with more accuracy.

In some embodiments, these measurement procedures may be based on at least one measurement quantity selected from a group consisted of: a SSB based RSRP; a SSB based RSRQ; a SSB based SINR; a CSI-RS based RSRP; a CSI-RS based RSRQ; or a CSI-RS based SINR. It will be appreciated that the paging-based measurement procedure or the random access-based measurement procedure described above may be performed in association with an initial access to a cell of the network device, or in association with a connection re-establishment with the first cell, not limited to the connection establishment procedure. For the connection re-establishment procedure, there may be more time for the UE to perform the measurement since the whole procedure is relatively long. Thus, the UE can initiate the measurement procedure a bit earlier than that discussed above (e.g., before the PRACH). As long as the delay (or duration) for the connection re-establishment procedure is longer than the periodicity of the measurement, the UE can report the measurement result in a timely manner.

### L1 Measurement/L3 Measurement

In some embodiments, both the L1 measurement and the L3 measurement can be applied for the paging-based measurement procedure or the random access-based measurement procedure. The L1 measurement can be referred to as a quick measurement compared to the regular L3 measurement, in terms of not involving processing/filtering at higher layers.

For the L1 measurement on each carrier, in FR1 and FR2, the UE may perform a one-shot measurement (i.e., based on one sample). In some examples, a periodicity of the measurement procedure based on the L1 measurement may be configured based on a periodicity of a target reference signal. For example, the periodicity based on the L1 measurement can be set equal to the target reference signal periodicity. In some implementations, beam sweeping may be enabled for the FR2 (or FR1) communication. Thus, the periodicity may be multiplied by an assumed number (e.g., M) of RX beams at the UE. For example, for the UE of a power class 1 (e.g., PC1), the assumed number is eight (8), and five (5) for UEs of other power classes.

For the L3 measurement on each carrier, in FR1 and FR2, the UE may perform a regular measurement based on N samples. In some examples, a periodicity of the measurement procedure based on the L3 measurement may be configured based on a periodicity of a target reference signal and the number N of samples. For example, the periodicity based on the L1 measurement can be set equal to the target reference signal periodicity multiplied by the number N. In some implementations, beam sweeping may be enabled for the FR2 (or FR1) communication. Thus, the above periodicity may be further multiplied by an assumed number (e.g., Measurement) of RX beams at the UE (for example, eight (8) or five (5).

In some implementations, a first capability can be defined for the UE, indicating a number of carriers the UE can measure simultaneously for the measurement procedure. For example, the number can be set equal to a number (e.g., X) of independent searchers for simultaneous measurements by the UE. The capability may be the same or different for the L1 and L3 measurement. In some embodiments, the periodicity of the measurement procedure will further depend on a number (e.g., K) of carriers the UE is to measure as well as the first capability.

For example, when the measurement procedure is performed on K carriers, if the first capability indicates the UE does not support simultaneous measurements on multiple carriers, the periodicity of the measurement procedure will be multiplied by the number of the carriers, K. If the first capability indicates the UE supports X simultaneous L1 measurements on multiple carriers, the periodicity of the measurement procedure will be multiplied by the number K and divided by X. The following tables show some example periodicities for measurement under different conditions.

TABLE 1
Measurement Periodicity, K carriers, one Searcher (N = 5, PC1)

| Periodicity | | Beam | |
|---|---|---|---|
| of | L1 or L3 | Sweeping | |
| Target RS | Measurement | Enabled | Periodicity for Measurement |
| Trs | L1 | No | Tmeasure = Trs × K |
| Trs | L1 | Yes | Tmeasure = 8 × Trs × K |
| Trs | L3 | No | Tmeasure = 5 × Trs × K |
| Trs | L3 | Yes | Tmeasure = 5 × 8 × Trs × K |

TABLE 2
Measurement Periodicity, K carriers, X Searchers (N = 5, PC1)

| Periodicity of | L1 or L3 | Beam Sweeping | |
|---|---|---|---|
| Target RS | Measurement | Enabled | Periodicity for Measurement |
| Trs | L1 | No | Tmeasure = ceiling(Trs × K/X) |
| Trs | L1 | Yes | Tmeasure = ceiling(8 × Trs × K/X) |
| Trs | L3 | No | Tmeasure = ceiling(5 × Trs × K/X) |
| Trs | L3 | Yes | Tmeasure = ceiling(5 × 8 × Trs × K/X) |

In some embodiments, the network device may include an indication in the first configuration 311 or the second configuration 411 (or any report configuration for the measurement), in order to configure the UE to perform the L1 measurement or the L3 measurement during the measurement procedure. If the indication explicitly corresponds to the L1 measurement (e.g., a flag for the L1 measurement), the UE will perform the paging-based measurement or the random access-based measurement by performing the simple L1 measurement. This first option would be useful to obtain the measurement results quickly, and would be desired when a handover is expected based on the measurement results, for example. If the indication explicitly corresponds to the L3 measurement (e.g., a flag for the L3 measurement), then the UE will perform the paging-based measurement or the random access-based measurement by performing the regular L3 measurement. This second option would be useful to obtain the measurement results with more accuracy.

In addition to the above explicit indication or as an alternative, the UE may be configured to determine to perform the L1 measurement or the L3 measurement based on a threshold. For example, the threshold may correspond to quality of L1 measurements already performed. The quality may be evaluated based on any measurement quantity, such as a SSB based RSRQ, a SSB based SINR, a CSI-RS based RSRP, a CSI-RS based RSRQ, or a CSI-RS based SINR. In some embodiments, the threshold may be configured as an indication in the first configuration 311 or the second configuration 411 (or any report configuration for the measurement), or the threshold may be predefined for the UE in corresponding technical specifications.

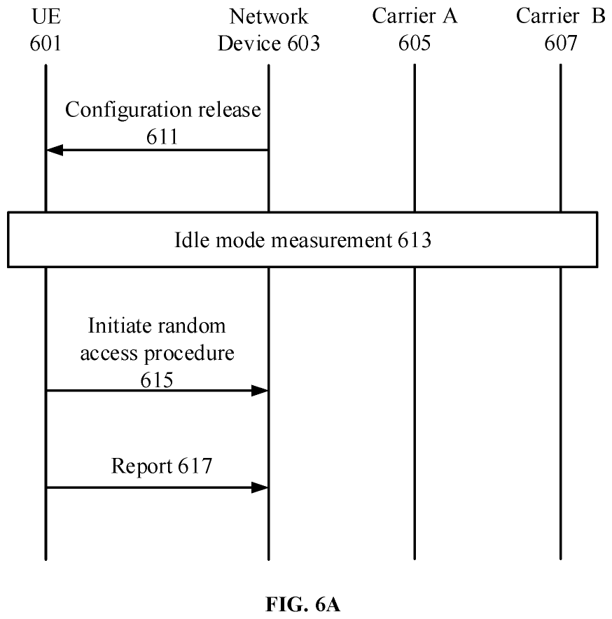

FIG. 5 illustrates an example process 500 for determining a type of measurement to perform based on a threshold, according to embodiments disclosed herein. The process 500 may be performed by a UE, such as any of the UEs and the wireless device of FIG. 1 and FIG. 2.

As shown in FIG. 5, at 501, the UE determines the quality of L1 measurements already performs. It will be appreciated that, even when the L3 measurement is first configured, the UE can obtain the L1 measurement results by using the L1 processing involved in the L3 measurement. The quality may be evaluated based on any measurement quantity, such as a SSB based RSRQ, a SSB based SINR, a CSI-RS based RSRP, a CSI-RS based RSRQ, or a CSI-RS based SINR.

At 503, the UE determines if a first condition or a second condition is met based on the quality of L1 measurements already performed. In some examples, the first condition corresponds to the quality of L1 measurement being not below a first threshold, which means the quality of the L1 measurement is good enough and it may not be necessary to perform the regular L3 measurement. In contrast, the second condition corresponds to the quality of L1 measurement being below a second threshold, which means the quality of the L1 measurement is not good enough and the regular L3 measurement is necessary to evaluate the quality of communication on the corresponding carrier(s). In some implementations, the first threshold may be higher than or equal to the second threshold.

Accordingly, at 505, the UE determines to perform the L1 measurement in response to the fact the first condition is met. In response to the fact the second condition is met, the UE determines to perform the L3 measurement at 507.

### Collision Handling

During the paging-based or random access-based measurement procedure, there may be traffic or data on other channels for the UE's reception. In some implementations, there may be collisions between the measurement performed by the UE and the UE's reception on any of the other channels (e.g., a first channel). For example, an SSB for the UE's measurement and the Msg. 4 for the UE's reception in the random access procedure may overlap with each other. It is possible that the SSB and Msg. 4 are carried with different sub-carrier spacings or are transmitted on different beams (e.g., in FR2). When the UE does not support simultaneousRxDataSSB-DiffNumerology or independent beam management (IBM), it is desired that the collisions between the measurement procedure and the other channels are handled appropriately.

In some embodiments, the network device may include in the first configuration 311 or the second configuration 411 (or any report configuration for the measurement) an indication of a measurement gap of the measurement procedure. For example, the measurement gap is reflected in some measurement pattern. Thus, for the measurement procedure and the first channel which are configured with different sub-carrier spacings or correspond to different beams, when the UE detects a collision between the measurement procedure and communications on the first channel, the UE may determine to prioritize the measurement procedure over the first channel. In this example, the configured measurement gap is used by the UE as an implicit indication that the measurement procedure is prioritized over the first channel. In some examples, the UE may monitor the first channel to detect communication thereon, when the detected communication overlaps over the configured measurement gap, the collision is detected.

In some embodiments, the network device may include in the first configuration 311 or the second configuration 411 (or any report configuration for the measurement) respective priorities of the measurement procedure and the first channel. Thus, for the measurement procedure and the first channel which are configured with different sub-carrier spacings or correspond to different beams, when the UE detects a collision between the measurement procedure and communications on the first channel, based on the respective priorities of the measurement procedure and the first channel, the UE may perform one with a higher priority with the other suspended, delayed or missed.

In some embodiments, when the priorities and the measurement gaps are both configured, either the configured priorities will override the measurement gaps or the configured measurement gaps will override the configured priorities, which may be predefined based on some technical specifications.

### Improved EMR

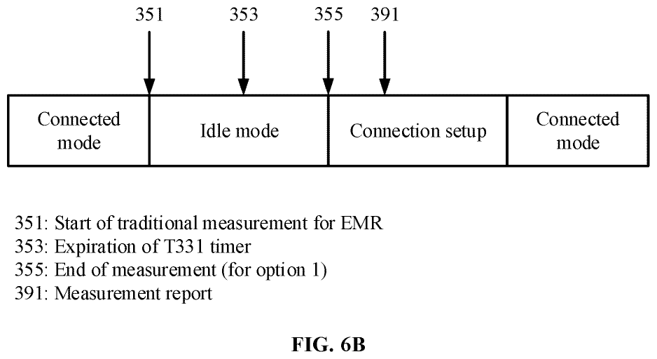

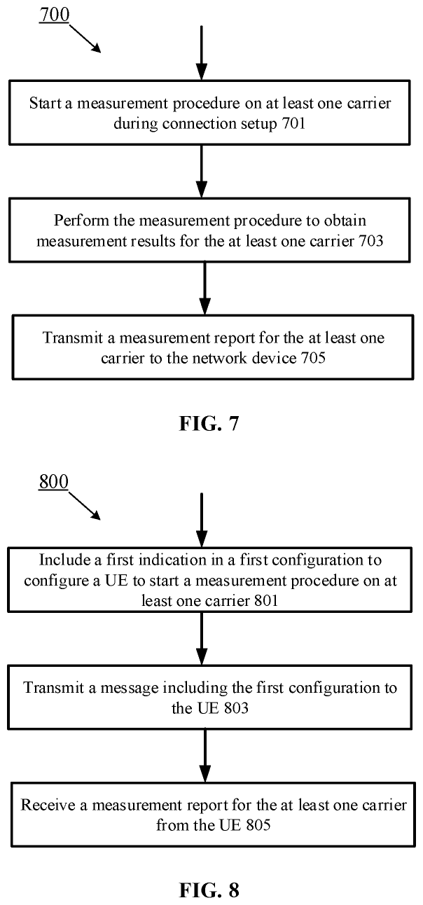

FIG. 6A illustrates an example flowchart for a measurement procedure performed during an idle mode, according to embodiments disclosed herein. In the example of FIG. 6A, the measurement procedure may be based on the traditional measurement for EMR. The improvements in accordance with some embodiments herein will be discussed in detail below. In FIG. 6A, the UE 601 may correspond to any of the UEs and the wireless device of FIG. 1 and FIG. 2. The network device 603 may correspond to any of the base stations or the network device of FIG. 1 and FIG. 2. The network device 603 may serve the UE 601 on one or more carriers.

As shown in FIG. 6A, at 611, the network device 603 transmits a connection release message to the UE 601. For example, during the connection release, the network device 603 may configure the UE 601 to perform measurements for EMR (or early measurements) on one or more carriers.

At 613, the UE 601 enters the idle mode and performs the early measurement as configured by the network device 603. For example, when a timer (e.g. the T331 timer) is running, the UE may perform measurements on the configured carriers for obtaining measurement results for the EMR. In some examples, the configured carriers include one or more carriers provided by the network device 603, or further include the carrier A 605 and the carrier B 607 provided by some other network device(s).

The idle mode may end with a random access procedure initiated by the UE 601, at 615. The random access procedure triggers the UE 601 to enter the connection setup procedure. At 617, the UE 601 may provide the EMR to the network device 603 during the connection setup procedure, either by itself or on the request of the network device 603.

FIG. 6B illustrates an example timeline for the measurement procedure in FIG. 6A, according to embodiments disclosed herein. As shown in FIG. 6B, the time at 351 may correspond to the UE 601 starts the early measurements during the idle mode. The time at 353 may correspond to expiration of the T331 timer. In some embodiments, as an option 1), the UE 601 may continue the early measurements even after the T331 timer expires. In this way, the UE 601 can obtain younger measurement results for reporting during the connection setup procedure. It will be appreciated that this benefit is at the cost of power consumption of the UE 601 during the prolonged measurement after expiration of the T331 timer. In some examples, the measurement may be prolonged to the time at 355 where the connection setup begins. The UE 601 may provide the measurement report to the network device 603 at 391.

In some embodiments, as an option 2), the UE 601 may stop the early measurement at 353 when the T331 timer expires, and may provide the measurement report to the network device 603 at 391, with the measurement procedure not being prolonged. After receiving the EMR from the UE 601, the network device 603 may determine a time period between a first time when the EMR is received and a second time when the T331 timer expired. A relation or mapping between the time period and degradation of the accuracy of the measurement report can be predefined. An example can be seen in Table 3 below. A degradation of accuracy for the EMR may be determined based on the time period, and a measurement result contained in the EMR may be adjusted based on the accuracy degradation. For example, when the EMR is received later than the time when the T331 timer expired by 1,000 ms, the network device 603 will assume a 2 dB degradation in the accuracy of the measurement report. In this example, a default accuracy of the measurement report is ±3 dB, the adjusted accuracy considering the 2 dB degradation will be ±5 dB.

TABLE 3

| Time period (ms) | Degradation (dB) |
|---|---|
| 500 | 1 |
| 1,000 | 2 |
| 2,000 | 4 |

### Example Method for the UE

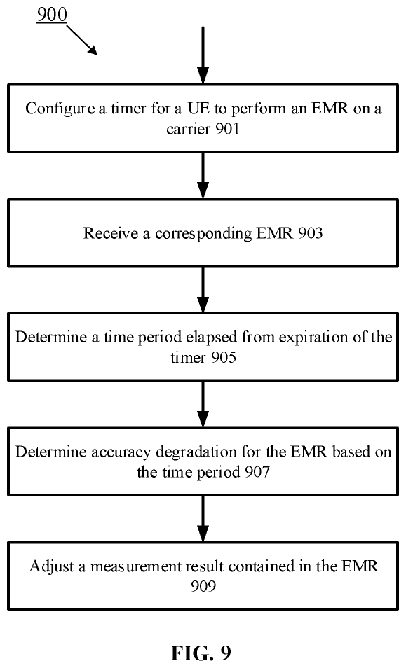

FIG. 7 illustrates an example method 700 for communication according to embodiments disclosed herein. The method 700 can be performed by a UE with a network device. In FIG. 7, the UE may correspond to any of the UEs and the wireless device of FIG. 1 and FIG. 2. The network device may correspond to any of the base stations or the network device of FIG. 1 and FIG. 2. The network device may serve the UE on one or more carriers.

As shown in FIG. 7, at 701, based on a first configuration, the UE may start a measurement procedure on at least one carrier in connection with a paging procedure or a random access procedure on a first cell. In some examples, the at least one carrier is associated with one or more cells including the first cell, and the first cell is provided by the network device. At 703, the UE may perform the measurement procedure to obtain measurement results for the at least one carrier. At 705, the UE may transmit a measurement report for the at least one carrier, containing the measurement results, to the network device.

In some embodiments, performing the measurement procedure during the connection setup procedure comprises starting the measurement procedure in connection with a paging procedure or a random access procedure on the first cell.

In some embodiments, starting the measurement procedure in connection with the paging procedure on the first cell comprises starting the measurement procedure during the paging procedure or after a successful paging reception. In some embodiments, starting the measurement procedure in connection with the random access procedure on the first cell comprises starting the measurement procedure: after a first RACH preamble transmission; after a successful RAR reception; after a successful RRC connection request transmission; or after a successful connection setup reception.

In some embodiments, the at least one carrier comprises a first carrier and a second carrier both associated with the first cell, or comprises a first carrier associated with the first cell and a third carrier associated with a second cell. In some embodiments, performing the measurement procedure on the at least one carrier comprises performing parallel measurement procedures on the first carrier and the second carrier, or on the first carrier and the third carrier.

In some embodiments, the paging procedure or the random access procedure is performed in association with an initial access to the first cell, a connection establishment procedure with the first cell, or a connection re-establishment with the first cell.

In some embodiments, the method further comprises performing the measurement procedure based on at least one measurement quantity selected from a group consisted of: a SSB based RSRP; a SSB based RSRQ; a SSB based SINR; a CSI-RS based RSRP; a CSI-RS based RSRQ; or a CSI-RS based SINR.

In some embodiments, the measurement procedure comprises at least one of a L1 measurement or a L3 measurement, and wherein the processor is further configured to cause the UE to: perform the L1 measurement or the L3 measurement based on an indication of the first configuration; perform the L1 measurement if a first condition is met; or perform the L3 measurement if a second condition is met.

In some embodiments, the first condition comprises a measurement quantity of the L1 measurement is not below a first threshold, and the second condition comprises the measurement quantity of the L1 measurement is below the first threshold.

In some embodiments, the method further comprises: detecting a collision between the measurement procedure and a first channel, at least in response to determining the measurement procedure and the first channel are configured with different sub-carrier spacings or correspond to different beams; and determining to prioritize the measurement procedure over the first channel when a measurement gap is configured for the measurement procedure by the first configuration, or determine respective priorities of the measurement procedure and the first channel based on an indication in the first configuration.

In some embodiments, the first configuration is carried, and received by the UE, in a message during an RRC release procedure or in a SIB, or the first configuration is predefined for the UE and the network device.

Embodiments contemplated herein include an apparatus comprising means to perform one or more elements of the method 700. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 700. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 202 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

### Example Method for the Network Device

FIG. 8 illustrates an example method 800 for communication according to embodiments disclosed herein. The method 800 can be performed by a network device with a UE. In FIG. 8, the network device may correspond to any of the base stations or the network device of FIG. 1 and FIG. 2. The UE may correspond to any of the UEs and the wireless device of FIG. 1 and FIG. 2. The network device may serve the UE on one or more carriers.

As shown in FIG. 8, at 801, the network device may include a first indication in a first configuration to configure the UE to perform a measurement procedure on at least one carrier during a connection setup procedure on a first cell, wherein the at least one carrier is associated with one or more cells including the first cell, and the first cell is provided by the network device. At 803, the network device may transmit a message including the first configuration to the UE. At 805, the network device may receive a measurement report for the at least one carrier, containing the measurement results, from the UE.

In some embodiments, performing the measurement procedure during the connection setup procedure comprises starting the measurement procedure in connection with a paging procedure or a random access procedure on the first cell.

In some embodiments, the first indication configures the UE to: start the measurement procedure during the paging procedure or after a successful paging reception; or start the measurement procedure: after a first RACH preamble transmission; after a successful RAR reception; after a successful RRC connection request transmission; or after a successful connection setup reception.

In some embodiments, the at least one carrier comprises a first carrier and a second carrier associated with the first cell, or comprises a first carrier associated with the first cell and a third carrier associated with a second cell, and the first indication configures the UE to perform parallel measurement procedures on the first carrier and the second carrier, or on the first carrier and the third carrier.

In some embodiments, the first indication configures the UE to perform the paging procedure or the random access procedure in association with an initial access to the first cell, a connection establishment procedure with the first cell, or a connection re-establishment with the first cell.

In some embodiments, the first indication configures the UE to perform the measurement procedure based on at least one measurement quantity selected from a group consisted of: a SSB based RSRP; a SSB based RSRQ; a SSB based SINR; a CSI-RS based RSRP; a CSI-RS based RSRQ; or a CSI-RS based SINR.

In some embodiments, the measurement procedure comprises at least one of a L1 measurement or a L3 measurement, and the method further comprises: including a second indication in the first configuration to configure the UE to perform the L1 measurement or the L3 measurement; or including a first threshold in the first configuration to configure the UE to perform the L1 measurement if a first condition is met or to perform the L3 measurement if a second condition is met.

In some embodiments, the first condition comprises a measurement quantity of the L1 measurement is not below a first threshold, and the second condition comprises the measurement quantity of the L1 measurement is below the first threshold.

In some embodiments, the method further comprises, for the measurement procedure and a first channel which are configured with different sub-carrier spacings or correspond to different beams, including in the first configuration a third indication of a measurement gap of the measurement procedure or respective priorities of the measurement procedure and the first channel.

In some embodiments, the method further comprises transmitting the first message during an RRC release procedure or in a SIB.

FIG. 9 illustrates an example method 900 for communication according to embodiments disclosed herein. The method 900 can be performed by a network device with a UE. In FIG. 9, the network device may correspond to any of the base stations or the network device of FIG. 1 and FIG. 2. The UE may correspond to any of the UEs and the wireless device of FIG. 1 and FIG. 2. The network device may serve the UE on one or more carriers.

As shown in FIG. 9, at 901, the network device may configure a timer for the UE to perform an early measurement on a carrier. At 903, the network device may receive a corresponding early measurement report. At 905, the network device may determine a time period between a first time when the early measurement report is received and a second time when the timer expired, i.e., determine a time period elapsed from expiration of the timer. At 907, the network device may determine a degradation of accuracy for the early measurement report based on the time period. At 909, the network device may adjust a measurement result contained in the early measurement report based on the degradation of the accuracy.

Embodiments contemplated herein include an apparatus comprising means to perform one or more elements of the methods 800 and 900. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the methods 800 and 900. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the methods 800 and 900. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the methods 800 and 900. This apparatus may be, for example, an apparatus of a base station (such as a network device 218 that is a base station, as described herein).

Embodiments contemplated herein include a signal as described in or related to one or more elements of the methods 800 and 900.

Embodiments contemplated herein include a computer program or computer program product comprising instructions, wherein execution of the program by a processing element is to cause the processing element to carry out one or more elements of the methods 800 and 900. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment device (UE), comprising:
one or more antennas configured to perform wireless communications;
a transceiver coupled to the one or more antennas; and
a processor coupled to the transceiver and configured to cause the UE to:
based on a first configuration, perform a measurement procedure on at least one carrier during a connection setup procedure on a first cell, wherein the at least one carrier is associated with one or more cells including the first cell, and the first cell is provided by a network device;
perform the measurement procedure to obtain measurement results for the at least one carrier; and
transmit a measurement report for the at least one carrier, containing the measurement results, to the network device.

2. The UE of claim 1, wherein performing the measurement procedure during the connection setup procedure comprises starting the measurement procedure in connection with a paging procedure or a random access procedure on the first cell.

3. The UE of claim 2, wherein starting the measurement procedure in connection with the paging procedure on the first cell comprises starting the measurement procedure during the paging procedure or after a successful paging reception; and
wherein starting the measurement procedure in connection with the random access procedure on the first cell comprises starting the measurement procedure:
after a first RACH preamble transmission;
after a successful RAR reception;
after a successful RRC connection request transmission; or
after a successful connection setup reception.

4. The UE of claim 2, wherein the at least one carrier comprises a first carrier and a second carrier both associated with the first cell, or comprises a first carrier associated with the first cell and a third carrier associated with a second cell, and performing the measurement procedure on the at least one carrier comprises performing parallel measurement procedures on the first carrier and the second carrier, or on the first carrier and the third carrier.

5. The UE of claim 2, wherein the paging procedure or the random access procedure is performed in association with an initial access to the first cell, a connection establishment procedure with the first cell, or a connection re-establishment with the first cell.

6. The UE of claim 1, wherein the processor is further configured to cause the UE to perform the measurement procedure based on at least one measurement quantity selected from a group consisted of: a SSB based RSRP; a SSB based RSRQ; a SSB based SINR; a CSI-RS based RSRP; a CSI-RS based RSRQ; or a CSI-RS based SINR.

7. The UE of claim 1, wherein the measurement procedure comprises at least one of a L1 measurement or a L3 measurement, and wherein the processor is further configured to cause the UE to:
perform the L1 measurement or the L3 measurement based on an indication of the first configuration;
perform the L1 measurement if a first condition is met; or
perform the L3 measurement if a second condition is met.

8. The UE of claim 1, wherein the first condition comprises a measurement quantity of the L1 measurement is not below a first threshold, and the second condition comprises the measurement quantity of the L1 measurement is below the first threshold.

9. The UE of claim 1, wherein the processor is further configured to cause the UE to:
detect a collision between the measurement procedure and a first channel, at least in response to determining the measurement procedure and the first channel are configured with different sub-carrier spacings or correspond to different beams; and
determine to prioritize the measurement procedure over the first channel when a measurement gap is configured for the measurement procedure by the first configuration, or determine respective priorities of the measurement procedure and the first channel based on an indication in the first configuration.

10. The UE of claim 1, wherein the first configuration is carried, and received by the UE, in a message during an RRC release procedure or in a SIB, or the first configuration is predefined for the UE and the network device.

11. A network device, comprising:
one or more antennas configured to perform wireless communications;
a transceiver coupled to the one or more antennas; and
a processor coupled to the transceiver and configured to cause the network device to:
include a first indication in a first configuration to configure a user equipment device (UE) to perform a measurement procedure on at least one carrier during a connection setup procedure on a first cell, wherein the at least one carrier is associated with one or more cells including the first cell, and the first cell is provided by the network device;
transmit a message including the first configuration to the UE; and
receive a measurement report for the at least one carrier, containing the measurement results, from the UE.

12. The network device of claim 11, wherein performing the measurement procedure during the connection setup procedure comprises starting the measurement procedure in connection with a paging procedure or a random access procedure on the first cell.

13. The network device of claim 12, wherein the first indication configures the UE to:
start the measurement procedure during the paging procedure or after a successful paging reception; or
start the measurement procedure: after a first RACH preamble transmission; after a successful RAR reception; after a successful RRC connection request transmission; or after a successful connection setup reception.

14. The network device of claim 12, wherein the at least one carrier comprises a first carrier and a second carrier associated with the first cell, or comprises a first carrier associated with the first cell and a third carrier associated with a second cell, and the first indication configures the UE to perform parallel measurement procedures on the first carrier and the second carrier, or on the first carrier and the third carrier.

15. The network device of claim 12, wherein the first indication configures the UE to perform the paging procedure or the random access procedure in association with an initial access to the first cell, a connection establishment procedure with the first cell, or a connection re-establishment with the first cell.

16. The network device of claim 11, wherein the first indication configures the UE to perform the measurement procedure based on at least one measurement quantity selected from a group consisted of: a SSB based RSRP; a SSB based RSRQ; a SSB based SINR; a CSI-RS based RSRP; a CSI-RS based RSRQ; or a CSI-RS based SINR.

17. The network device of claim 11, wherein the measurement procedure comprises at least one of a L1 measurement or a L3 measurement, and
wherein the processor is further configured to cause the network device to:
include a second indication in the first configuration to configure the UE to perform the L1 measurement or the L3 measurement; or
include a first threshold in the first configuration to configure the UE to perform the L1 measurement if a first condition is met or to perform the L3 measurement if a second condition is met.

18. The network device of claim 11, wherein the first condition comprises a measurement quantity of the L1 measurement is not below a first threshold, and the second condition comprises the measurement quantity of the L1 measurement is below the first threshold.

19. The network device of claim 11, wherein the processor is further configured to cause the network device to:
for the measurement procedure and a first channel which are configured with different sub-carrier spacings or correspond to different beams, include in the first configuration a third indication of a measurement gap of the measurement procedure or respective priorities of the measurement procedure and the first channel.

20. The network device of claim 11, wherein the processor is further configured to cause the network device to:
transmit the first message during an RRC release procedure or in a SIB.

21-25. (canceled)
